(19) United States
(12) Patent Application Publication
(10) Pub. No.: US 2026/0362523 A1
(43) Pub. Date: Nov. 12, 2026

(54) METHOD AND DEVICE FOR SETTING UP LOW LATENCY SESSION AND MANAGING PROCEDURES DURING LOW LATENCY SESSION

(71) Applicant: MEDIATEK INC., Hsinchu City (TW)

(72) Inventors: Chien-Fang Hsu, Hsinchu City (TW); James Chih-Shi Yee, San Jose, CA (US)

(73) Assignee: MEDIATEK INC., Hsinchu City (TW)

(21) Appl. No.: 19/475,076

(22) PCT Filed: Jan. 15, 2025
(86) PCT No.: PCT/CN2025/072493

§ 371 Date: Oct. 14, 2025

Related U.S. Application Data
(60) Provisional application No. 63/621,635, filed on Jan. 17, 2024.

(51) Int. Cl. H04W 76/15; H04W 84/12

(52) U.S. Cl. CPC H04W 76/15; H04W 84/12

(57) ABSTRACT

A wireless communication method includes: generating a first frame, wherein the first frame includes setup parameters of a low latency (LL) session; and sending the first frame to a wireless communication device. For example, the wireless communication device is a Wi-Fi access point (AP), and the wireless communication method is employed by a Wi-Fi non-AP station (STA). For another example, the wireless communication device is a Wi-Fi AP MLD, and the wireless communication method is employed by a Wi-Fi non-AP MLD.

### BACKGROUND OF THE INVENTION

### 1. Field of the Invention

The present invention relates to wireless communications, and more particularly, to a method and device for setting up a low latency (LL) session and managing procedures during the LL session.

### 2. Description of the Prior Art

In the Wi-Fi systems, to ensure the LL traffic delivery is the key goal of the technology development. An access point (AP) may support a variety of features that can improve the LL traffic delivery. However, not all of non-AP stations (STAs) associated to the same AP may need these LL traffic delivery improvement features anytime due to the fact that the non-AP STAs (clients) do not have LL sensitive traffic all the time. Thus, there is a need for an innovative design which can allow one non-AP STA to enable these LL traffic delivery improvement features on demand.

### SUMMARY OF THE INVENTION

One of the objectives of the claimed invention is to provide a method and device for setting up a LL session and managing procedures during the LL session.

According to a first aspect of the present invention, an exemplary wireless communication method is disclosed. The exemplary wireless communication method includes: generating a first frame, wherein the first frame includes setup parameters of a LL session; and sending the first frame to a wireless communication device.

According to a second aspect of the present invention, an exemplary wireless communication device is disclosed. The exemplary wireless communication device includes a network interface circuit and a control circuit. The control circuit is arranged to generate a first frame, and instruct the network interface circuit to send the first information to another wireless communication device, wherein the first frame includes setup parameters of a LL session between the wireless communication device and the another wireless communication device.

According to a third aspect of the present invention, an exemplary wireless communication method is disclosed. The exemplary wireless communication method includes: receiving a first frame from a wireless communication device, wherein the first frame comprises setup parameters of a low latency (LL) session; and parsing the setup parameters of the LL session from the first frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first wireless communication system that supports the proposed LL session setup and management scheme according to an embodiment of the present invention.

FIG. 2 is a diagram illustrating a second wireless communication system that supports the proposed LL session setup and management scheme according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

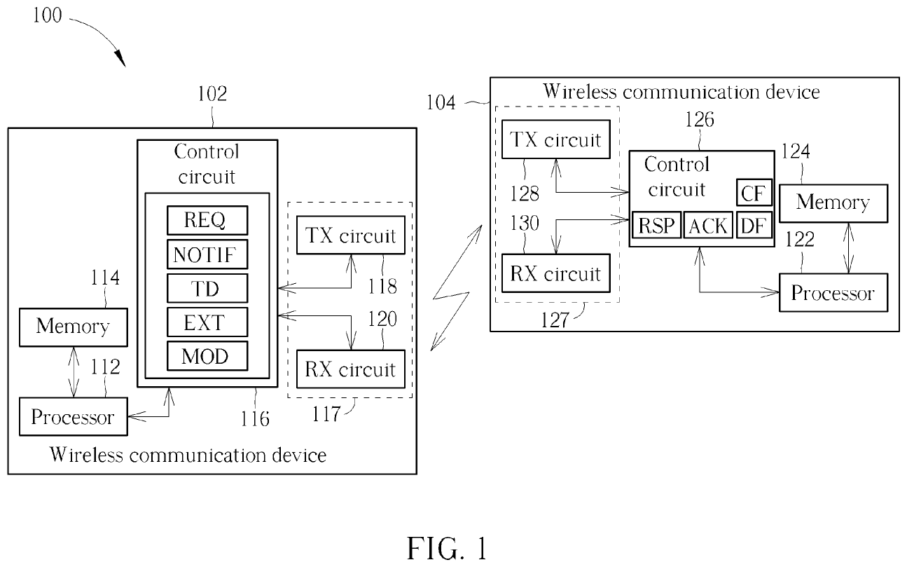

FIG. 1 is a diagram illustrating a first wireless communication system that supports the proposed LL session setup and management scheme according to an embodiment of the present invention. The wireless communication system 100 includes a plurality of wireless communication devices 102 and 104. For example, the wireless communication system 100 is a Wi-Fi system, including an AP and a non-AP STA. In one embodiment of the present invention, the wireless communication device 104 may be an AP, and the wireless communication device 102 may be a non-AP STA. For brevity and simplicity, only two wireless communication devices 102 and 104 are shown in FIG. 1. In practice, the wireless communication system 100 is allowed to have more than two wireless communication devices, including an AP and more than one non-AP STA in the same basic service set (BSS).

The wireless communication devices 102 and 104 may have the same or similar circuit structure. As shown in FIG. 1, the wireless communication device 102 includes a processor 112, a memory 114, a control circuit 116, and a network interface circuit 117, where the network interface circuit 117 includes a transmitter (TX) circuit 118 and a receiver (RX) circuit 120. The memory 114 is arranged to store a program code. The processor 112 is arranged to load and execute the program code to manage the wireless communication device 102. The control circuit 116 is arranged to control wireless communications with the wireless communication device 104. In a case where the wireless communication device 102 is a non-AP STA and the wireless communication device 104 is an AP, the control circuit 116 controls the TX circuit 118 of the network interface circuit 117 to deal with uplink (UL) traffic between AP and non-AP STA, and controls the RX circuit 120 of the network interface circuit 117 to deal with downlink (DL) traffic between AP and non-AP STA.

The wireless communication device 104 includes a processor 122, a memory 124, a control circuit 126, and a network interface circuit 127, where the network interface circuit 127 includes a TX circuit 128 and an RX circuit 130. The memory 124 is arranged to store a program code. The processor 122 is arranged to load and execute the program code to manage the wireless communication device 104. The control circuit 126 is arranged to control wireless communications with the wireless communication device 102. In a case where the wireless communication device 102 is a non-AP STA and the wireless communication device 104 is an AP, the control circuit 126 controls the TX circuit 128 of the network interface circuit 127 to deal with DL traffic between AP and non-AP STA, and controls the RX circuit 130 of the network interface circuit 127 to deal with UL traffic between AP and non-AP STA.

It should be noted that only the components pertinent to the present invention are illustrated in FIG. 1. In practice, the wireless communication device 102 may include additional components to achieve designated functions, and/or the wireless communication device 104 may include additional components to achieve designated functions.

The wireless communication device 102 acts as a client STA that is associated to the wireless communication device 104 that acts as an AP. The wireless communication devices 102 and 104 support the proposed LL session setup and management scheme.

In one LL session setup design, the control circuit 116 of the wireless communication device (e.g., non-AP STA) 102 may generate a request frame REQ, and instruct the network interface circuit 117 (particularly, TX circuit 118 of network interface circuit 117) to send the request frame REQ to the wireless communication device (e.g., AP) 104. After receiving the request frame REQ through the network interface circuit 127 (particularly, RX circuit 130 of network interface circuit 127), the control circuit 126 may generate a response frame RSP, and instruct the network interface circuit 127 (particularly, TX circuit 128 of network interface circuit 127) to send the response frame RSP to the wireless communication device (e.g., non-AP STA) 102.

The LL session setup procedure is initiated by the wireless communication device (e.g., non-AP STA) 102. The request frame REQ includes setup parameters of a LL session requested by the wireless communication device (e.g., non-AP STA) 102. After receiving the request frame REQ, the control circuit 126 parses the setup parameters of the requested LL session from the request frame REQ. For example, the setup parameters may include a session identifier (ID), at least one required feature from the wireless communication device (e.g., AP) 104 to help the LL traffic delivery, and timing information of the at least one required feature. For example, the LL traffic delivery improvement features supported by the wireless communication device (e.g., AP) 104 may include a shorter physical layer protocol data unit (PPDU) length over a transmission opportunity (TXOP), preemption of DL/UL TXOP, high priority enhanced distributed channel access (EDCA), etc. The timing information of a required feature may include a period of the required feature, or a starting time and an ending time that are set based on a timing synchronization function (TSF) timer. The response frame RSP may carry information indicative of acceptance or rejection of the LL session request, or may provide a counter proposal of the requested parameters carried in the request frame REQ. The LL session is established between the wireless communication device (e.g., non-AP STA) 102 and the wireless communication device (e.g., AP) 104 after the response frame RSP (which indicates the LL session request is accepted) is delivered from the wireless communication device (e.g., AP) 104 and received by the wireless communication device (e.g., non-AP STA) 102.

In some embodiments of the present invention, the request-response based LL session setup protocol may be embedded in an existing stream classification service (SCS) setup procedure. Hence, the request frame REQ may be an SCS request frame, and the response frame RSP may be an SCS response frame.

In another LL session setup design, the control circuit 116 of the wireless communication device (e.g., non-AP STA) 102 may generate a notification frame NOTIF, and instruct the network interface circuit 117 (particularly, TX circuit 118 of network interface circuit 117) to send the notification frame NOTIF to the wireless communication device (e.g., AP) 104. After receiving the notification frame NOTIF through the network interface circuit 127 (particularly, RX circuit 130 of network interface circuit 127), the control circuit 126 may generate an acknowledgement frame ACK, and instruct the network interface circuit 127 (particularly, TX circuit 128 of network interface circuit 127) to send the acknowledgement frame ACK to the wireless communication device (e.g., non-AP STA) 102.

The LL session setup procedure is initiated by the wireless communication device (e.g., non-AP STA) 102. The notification frame NOTIF includes setup parameters of a LL session requested by the wireless communication device (e.g., non-AP STA) 102. After receiving the notification frame NOTIF, the control circuit 126 parses the setup parameters of the requested LL session from the notification frame NOTIF. For example, the setup parameters may include a session ID, at least one required feature from the wireless communication device (e.g., AP) 104 to help the LL traffic delivery, and timing information of the at least one required feature. For example, the LL traffic delivery improvement features supported by the wireless communication device (e.g., AP) 104 may include a shorter PPDU length over a TXOP, preemption of DL/UL TXOP, high priority EDCA, etc. The timing information of one required feature may include a period of the required feature, or a starting time and an ending time that are set based on a TSF timer. The LL session is established between the wireless communication device (e.g., non-AP STA) 102 and the wireless communication device (e.g., AP) 104 after the acknowledgement frame ACK is delivered from the wireless communication device (e.g., AP) 104 and received by the wireless communication device (e.g., non-AP STA) 102.

After a LL session setup procedure initiated by the wireless communication device (e.g., non-AP STA) 102 is completed (i.e., a LL session is established between the wireless communication device (e.g., AP) 104 and the wireless communication device (e.g., non-AP STA) 102), one or more management procedures may be performed during the established LL session. The established LL session will be automatically terminated at the ending time indicated in the request frame REQ/notification frame NOTIF. In some embodiments of the present invention, the wireless communication device (e.g., non-AP STA) 102 is allowed to tear down the established LL session with the session ID before the ending time indicated in the request frame REQ/notification frame NOTIF. Specifically, the control circuit 116 of the wireless communication device (e.g., non-AP STA) 102 may generate a teardown announcement frame TD, and instruct the network interface circuit 117 (particularly, TX circuit 118 of network interface circuit 117) to send the teardown announcement frame TD to the wireless communication device (e.g., AP) 104, where the teardown announcement frame TD is indicative of teardown (i.e., early termination) of the established LL session.

In some embodiments of the present invention, the wireless communication device (e.g., non-AP STA) 102 is allowed to extend the established LL session before the ending time indicated in the request frame REQ/notification frame NOTIF. Specifically, the control circuit 116 of the wireless communication device (e.g., non-AP STA) 102 may generate an extension announcement frame EXT, and instruct the network interface circuit 117 (particularly, TX circuit 118 of network interface circuit 117) to send the extension announcement frame EXT to the wireless communication device (e.g., AP) 104, where the extension announcement frame EXT is indicative of extension (i.e., a new ending time) of the established LL session.

In some embodiments of the present invention, the wireless communication device (e.g., non-AP STA) 102 is allowed to modify at least one of setup parameters of the established LL session before the ending time indicated in the request frame REQ/notification frame NOTIF. Specifically, the control circuit 116 of the wireless communication device (e.g., non-AP STA) 102 may generate a parameter modification frame MOD, and instruct the network interface circuit 117 (particularly, TX circuit 118 of network interface circuit 117) to send the parameter modification frame MOD to the wireless communication device (e.g., AP) 104, where the parameter modification announcement frame MOD is indicative of modification of at least one setup parameter (e.g., new setup parameter (s)) of the established LL session. In response to receiving the parameter modification frame MOD, the wireless communication device (e.g., AP) 104 may send a response frame RSP with acceptance or rejection, or may send an acknowledgement frame ACK. New setup parameter(s) will apply when the response frame RSP with acceptance (or the acknowledgement frame ACK) is delivered.

Furthermore, during an established LL session, the wireless communication device (e.g., non-AP STA) 102 and/or the wireless communication device (e.g., AP) 104 may not always be able to provide the LL traffic delivery improvement feature(s) in each TXOP. For example, an AP may need to transmit a longer PPDU over the length limitation of a DL TXOP to make sure the carried traffic (close to the delay bound) can be delivered in time. For another example, the ongoing transmission is LL traffic requiring immediate resources so that other LL traffic may not interrupt. Thus, signaling to disable some features dynamically is necessary.

If the wireless communication device (e.g., AP) 104 uses a control frame CF (e.g., MU-RTS) to acquire the wireless medium, the control circuit 126 may use a frame body of the control frame CF to indicate disablement of at least one required LL traffic improvement feature within a duration of the established LL session, and send the control frame CF with disablement indication to the wireless communication device (e.g., non-AP STA) 102 for disabling the required LL traffic improvement feature for a specific period. The disablement may be TXOP based disablement (which can be performed in real time with less additional negotiation complexity) or period based disablement (which requires additional parameter exchange to specify the start and the end of the disablement, or starting/ending signaling).

If the wireless communication device (e.g., AP) 104 uses a data frame DF to acquire the wireless medium, the control circuit 126 may use an aggregated control (A-CTRL) field in a media access control (MAC) header of the data frame DF to indicate disablement of at least one required LL traffic improvement feature within a duration of the established LL session, and send the data frame DF with disablement indication to the wireless communication device (e.g., non-AP STA) 102 for disabling the required LL traffic improvement feature for a specific period. The disablement may be TXOP based disablement (which can be performed in real time with less additional negotiation complexity) or period based disablement (which requires additional parameter exchange to specify the start and the end of the disablement, or starting/ending signaling).

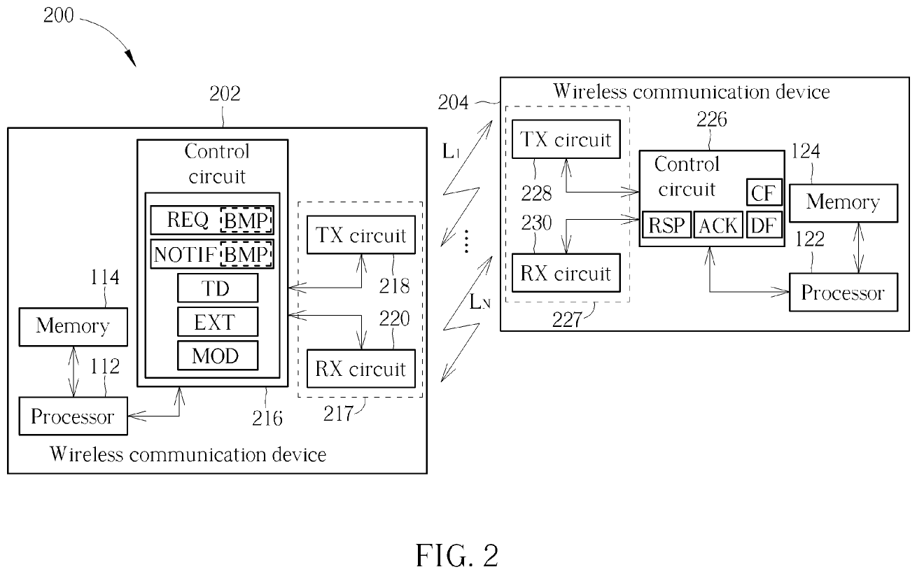

The proposed LL session setup and management scheme may also be employed by wireless communication devices operating under a multi-link operation (MLO) mode. FIG. 2 is a diagram illustrating a second wireless communication system that supports the proposed LL session setup and management scheme according to an embodiment of the present invention. The wireless communication system 200 includes a plurality of wireless communication devices 202 and 204. For example, the wireless communication system 200 is a Wi-Fi system, including an AP MLD (which owns multiple links working on different bands and capable of operating at the same time) and a non-AP MLD (which owns multiple links working on different bands and capable of operating at the same time). In one embodiment of the present invention, the wireless communication device 204 may be an AP MLD with multiple affiliated APs, and the wireless communication device 202 may be a non-AP MLD with multiple affiliated non-AP STAs. The wireless communication device (e.g., non-AP MLD) 202 is associated to the wireless communication device (e.g., AP MLD) 204. In addition, there are multiple setup links L₁-L_{N} (N≥2) between the wireless communication devices 202 and 204. Regarding the network interface circuit 217, the TX circuit 218 may include multiple transmitters, and the RX circuit 220 may include multiple receivers. Regarding the network interface circuit 227, the TX circuit 228 may include multiple transmitters, and the RX circuit 230 may include multiple receivers. The control circuits 216 and 226 may support the proposed LL session setup and management scheme. For brevity and simplicity, only two wireless communication devices 202 and 204 are shown in FIG. 2. In practice, the wireless communication system 200 is allowed to have more than two wireless communication devices, including an AP MLD and more than one non-AP MLDs.

In some embodiments of the present invention, one LL session with setup parameters indicated in the request frame REQ/notification frame NOTIF may be an MLD-level LL session applying to all setup links L₁-L_{N} between the wireless communication devices 202 and 204.

In some embodiments of the present invention, one LL session with setup parameters indicated in the request frame REQ/notification frame NOTIF may be a per-link LL session applying to one of the setup links L₁-L_{N} between the wireless communication devices 202 and 204, thereby allowing multiple different LL sessions on different setup links, respectively. Due to inherent characteristics of the per-link LL session, the wireless communication devices 202 and 204 may have multiple setup links (e.g., all setup links L₁-L_{N}), each having a designated per-link LL session applied thereto. It is also possible that the wireless communication devices 202 and 204 may have only one of the setup links L₁-L_{N} that has a per-link LL session applied thereto.

The LL session may not fit all setup links L₁-L_{N} because the corresponding parameters may not apply to all setup links L₁-L_{N}. For example, different traffic identifiers (TIDs) may be mapped to different links, and LL traffic TIDs may only apply to a subset of the setup links L₁-L_{N}. In some embodiments of the present invention, one LL session with setup parameters indicated in the request frame REQ/notification frame NOTIF may apply to all setup links included in a same subset of setup links L₁-L_{N} between the wireless communication devices 202 and 204. For example, the setup parameters indicated in the request frame REQ/notification frame NOTIF may include a link bitmap BMP that is set to indicate which setup links are included in the subset. If there is timing information of the requested session, the timing may need to be adjusted based on the TSF timer of each link.

In some embodiments of the present invention, one LL session with setup parameters indicated in the request frame REQ/notification frame NOTIF may be a per-link LL session applying to one setup link between the wireless communication devices 202 and 204, thereby allowing multiple different LL sessions on different setup links, respectively. For example, the setup parameters indicated in the request frame REQ/notification frame NOTIF may be applied to one specific setup link indicated by a link ID or a link bitmap BMP, and different setup parameters indicated in the request frame REQ/notification frame NOTIF may be applied to another specific setup link indicated by a link ID or the link bitmap BMP. If there is timing information of the requested session, the timing may need to be adjusted based on the TSF timer of each link.

In some embodiments of the present invention, during a period in which the LL session is set up, a specific feature to support LL traffic transmission and receive may be applied between the wireless communication devices 202 and 204 on a subset of setup links L₁-L_{N}.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method comprising:
generating a first frame, wherein the first frame comprises setup parameters of a low latency (LL) session; and
sending the first frame to a wireless communication device.

2. The wireless communication method of claim 1, wherein the wireless communication device is a Wi-Fi access point (AP) or AP multi-link device (MLD).

3. The wireless communication method of claim 1, further comprising:
receiving a second frame from the wireless communication device, wherein the second frame is sent from the wireless communication device in response to the first frame.

4. The wireless communication method of claim 3, wherein the first frame is a request frame, and the second frame is a response frame.

5. The wireless communication method of claim 4, wherein the request frame is a stream classification service (SCS) request frame, and the response frame is an SCS response frame.

6. The wireless communication method of claim 3, wherein the first frame is a notification frame, and the second frame is an acknowledgement frame.

7. The wireless communication method of claim 1, wherein the setup parameters comprise a session identifier (ID), at least one required feature from the wireless communication device to help LL traffic delivery, and timing information of the at least one required feature.

8. The wireless communication method of claim 1, wherein the wireless communication method is employed by a first Wi-Fi multi-link device (MLD), the wireless communication device is a second Wi-Fi MLD, and the LL session is an MLD-level LL session applying to all setup links between the first Wi-Fi MLD and the second Wi-Fi MLD.

9. The wireless communication method of claim 1, wherein the wireless communication method is employed by a first Wi-Fi multi-link device (MLD), the wireless communication device is a second Wi-Fi MLD, and the LL session is a per-link LL session applying to a setup link between the first Wi-Fi MLD and the second Wi-Fi MLD.

10. The wireless communication method of claim 9, wherein:
the setup link is any setup link between the first Wi-Fi MLD and the second Wi-Fi MLD; or
the setup link is any setup link included in a subset of setup links between the first Wi-Fi MLD and the second Wi-Fi MLD.

11. The wireless communication method of claim 1, wherein the wireless communication method is employed by a first Wi-Fi multi-link device (MLD), the wireless communication device is a second Wi-Fi MLD, and the LL session applies to all setup links included in a subset of setup links between the first Wi-Fi MLD and the second Wi-Fi MLD.

12. The wireless communication method of claim 11, wherein the setup parameters comprise a link bitmap that is set to indicate which setup links are included in the subset.

13. The wireless communication method of claim 1, further comprising:
after the LL session is established, generating a second frame, wherein the second frame is indicative of teardown of the LL session; and
sending the second frame to the wireless communication device.

14. The wireless communication method of claim 1, further comprising:
after the LL session is established, generating a second frame, wherein the second frame is indicative of extension of the LL session; and
sending the second frame to the wireless communication device.

15. The wireless communication method of claim 1, further comprising:
after the LL session is established, generating a second frame, wherein the second frame is indicative of modification of at least one of the setup parameters; and
sending the second frame to the wireless communication device.

16. The wireless communication method of claim 1, wherein the setup parameters comprise a required feature from the wireless communication device to help LL traffic delivery, and the wireless communication method further comprises:
after the LL session is established, receiving a second frame from the wireless communication device, wherein the second frame is indicative of disablement of the required

17. The wireless communication method of claim 16, wherein:
the second frame is a control frame, and the disablement is indicated in a frame body of the control frame; or
the second frame is a data frame, and the disablement is indicated in a media access control (MAC) header of the data frame.

18. The wireless communication method of claim 16, wherein the disablement is transmission opportunity (TXOP) based disablement or period based disablement.

19. The wireless communication method of claim 1, wherein the wireless communication method is employed by a first Wi-Fi multi-link device (MLD), the wireless communication device is a second Wi-Fi MLD, and during a period in which the LL session is set up, a specific feature to support LL traffic transmission and receive is applied between the first Wi-Fi MLD and the second Wi-Fi MLD on a subset of setup links between the first Wi-Fi MLD and the second Wi-Fi MLD.

20. A wireless communication device comprising:
a network interface circuit; and
a control circuit, arranged to generate a first frame, and instruct the network interface circuit to send the first information to another wireless communication device, wherein the first frame comprises setup parameters of a low latency (LL) session between the wireless communication device and the another wireless communication device.

21. A wireless communication method comprising:
receiving a first frame from a wireless communication device, wherein the first frame comprises setup parameters of a low latency (LL) session; and
parsing the setup parameters of the LL session from the first frame.

22. The wireless communication method of claim 21, wherein the wireless communication device is a Wi-Fi non-access-point (non-AP) station (STA) or non-AP multi-link device (MLD).
